(19) United States
(12) Patent Application Publication
(10) Pub. No.: US 2013/0293942 A1
(43) Pub. Date: Nov. 7, 2013

(54) METHOD FOR OPTIMIZING HYPERFINE APERIODIC OPTICAL SUPERLATTICE

(71) Applicants: Jui-Yu LAI, Changhua County (TW); Shang-Da YANG, Hsinchu City (TW)

(72) Inventors: Jui-Yu LAI, Changhua County (TW); Shang-Da YANG, Hsinchu City (TW)

(73) Assignee: NATIONAL TSING HUA UNIVERSITY, HSINCHU (TW)

(21) Appl. No.: 13/460,849

(22) Filed: May 1, 2012

(51) Int. Cl. G02F 1/03

(52) U.S. Cl. 359/245

(57) ABSTRACT

A method for optimizing a hyperfine aperiodic optical superlattice (HAOS) is provided. In the method, the HAOS is divided into a plurality of unit blocks with the same length, wherein the unit blocks has same spatial distribution of domain orientation, and the HAOS with an original conversion efficiency. The spatial distribution of domain orientation of one of the unit blocks is inverted. An achieved conversion efficiency of the HAOS with the inverted spatial distribution of domain orientation is calculated. The achieved conversion efficiency is compared with a target conversion efficiency. The HAOS with the achieved conversion efficiency which is closest to the target conversion efficiency as an optimized HAOS.

### BACKGROUND

1. Technical Field

The present invention relates to a method for optimizing a hyperfine aperiodic optical superlattice. More particularly, the present invention relates to a method for optimizing a hyperfine aperiodic optical superlattice that is for phase-matching engineering of the nonlinear wavelength conversion process.

2. Description of Related Art

Quasi-phase-matching (QPM) in ferroelectric materials has been widely used in plenty of wavelength conversion processes for achieving phase-matching (PM). In an application of gas sensing using several absorption lines and a high-sensitivity ultrashort pulse measurement, one needs discrete phase-matching (PM) peaks at pre-specified positions and a continuous PM spectrum with broad bandwidth, respectively. There have been some techniques, such as aperiodic optical superlattice (AOS) optimized by simulated annealing (SA) and nonperiodic optical superlattice (NOS) optimized by genetic algorithm (GA), capable of achieving arbitrary discrete PM peaks. However, the performances (conversion efficiency, spectral fidelity, and complexity of target PM peaks) of SA and GA are subjected to the limited number of unit blocks or domains, and no continuous PM spectrum has been demonstrated accordingly.

### SUMMARY

According to one aspect of the present disclosure, a method for optimizing a hyperfine aperiodic optical superlattice (HAOS) is provided. The method includes the steps as follows. The HAOS is divided into a plurality of unit blocks with the same length, wherein the unit blocks has same spatial distribution of domain orientation, and the HAOS with an original conversion efficiency. An inversion step is performed for inverting the spatial distribution of domain orientation of one of the unit blocks. A calculation step is performed for calculating an achieved conversion efficiency from a fundamental wavelength into a target wavelength of the HAOS which has the one of the unit blocks with the inverted spatial distribution of domain orientation. A comparison step is performed for comparing the achieved conversion efficiency with a target conversion efficiency. The inversion step, the calculation step and the comparison step performed on the others unit blocks are iterated block by block. The HAOS with the achieved conversion efficiency which is closest to the target conversion efficiency is selected as an optimized HAOS.

According to another aspect of the present disclosure, a system for optimizing a hyperfine aperiodic optical superlattice (HAOS) is disclosed. The system includes a receiving module, a calculating module, a comparing module and a selecting module. The receiving module receives the HAOS data and divides the HAOS into a plurality of unit blocks with the same length wherein the unit blocks has same spatial distribution of domain orientation, and the HAOS with an original conversion efficiency. The calculating module is connected to the receiving module and calculates an achieved conversion efficiency of the HAOS which has the one of the unit blocks with an inverted spatial distribution of domain orientation, wherein the spatial distribution of domain orientation of each of the unit blocks is inverted block by block. The comparing module is connected to the calculating module, wherein the comparing module is used for comparing the achieved conversion efficiency with a target conversion efficiency. The selecting module is connected to the comparing module, wherein the selecting module selects he HAOS with the achieved conversion efficiency which is closest to the target conversion efficiency as an optimized HAOS.

### BRIEF DESCRIPTION OF THE DRAWINGS

The invention can be more fully understood by reading the following detailed description of the embodiment, with reference made to the accompanying drawings as follows:

FIG. 1 is a flowchart showing a method for optimizing a hyperfine aperiodic optical superlattice (HAOS) according to one embodiment of the present disclosure;

FIG. 2 is a schematic drawing of the HAOS applied to the method of FIG. 1;

FIG. 3 is a functional block showing a system for optimizing a hyperfine aperiodic optical superlattice according to another embodiment of the present disclosure;

FIG. 4 Illustrates a fundamental wavelength—normalized conversion efficiency spectrum of an example 1, a comparison example 1 and a comparison example 2; and

FIG. 5 Illustrates a fundamental wavelength—normalized conversion efficiency spectrum of an example 2 and example 3.

### DETAILED DESCRIPTION

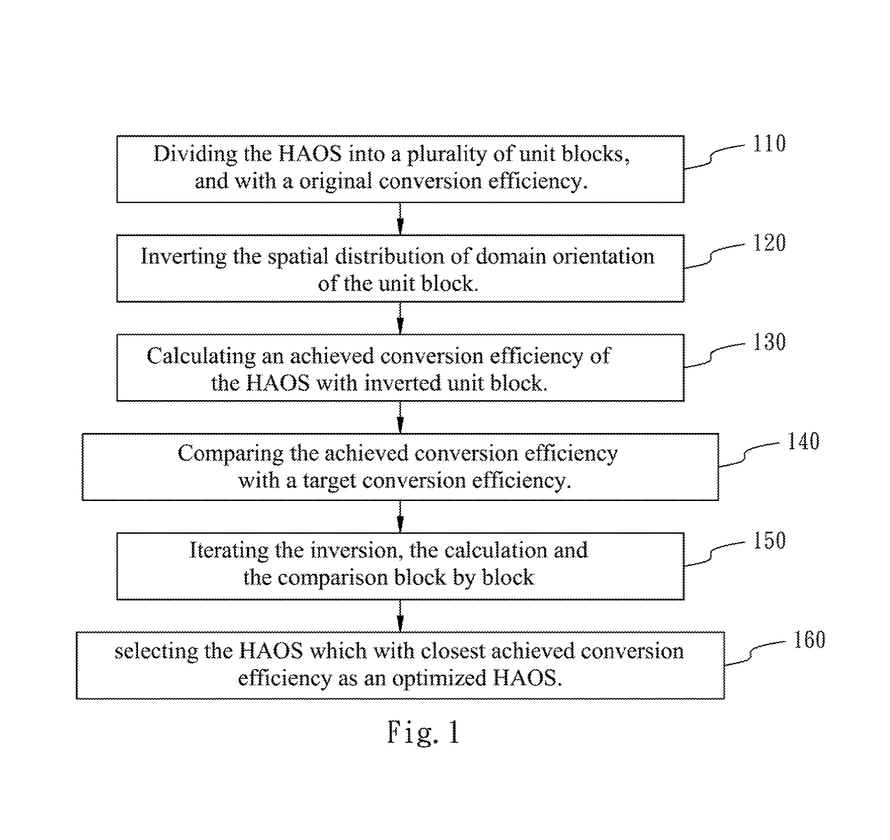

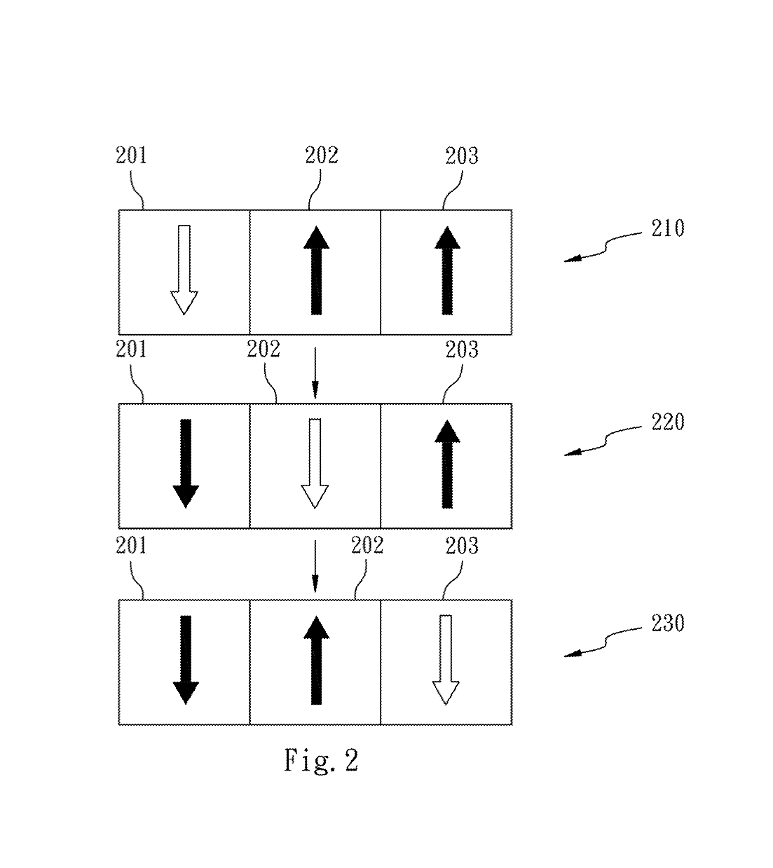

FIG. 1 is a flowchart showing a method for optimizing a hyperfine aperiodic optical superlattice (HAOS) according to one embodiment of the present disclosure. FIG. 2 is a schematic drawing of the HAOS applied to the method of FIG. 1. In FIG. 1, the method includes the steps as follows. In step 110, the HAOS is divided into a plurality of unit blocks with the same length (in FIG. 2, the HAOS is divided into three blocks 201, 202, 203), wherein the unit blocks has same spatial distribution of domain orientation, and the HAOS with an original conversion efficiency. In the embodiment of FIG. 1, a spatial distribution of domain orientation of each of the unit blocks are all positive at the beginning. In step 120, an inversion step is performed, wherein the spatial distribution of domain orientation of one of the unit blocks is inverted (such as step 210 in FIG. 2). In step 130, a calculation step is performed, wherein an achieved conversion efficiency from a fundamental wavelength into a target wavelength of the HAOS which has the one of the unit blocks with the inverted spatial distribution of domain orientation is calculated. In step 140, a comparison step is performed, wherein the achieved conversion efficiency calculated in step 130 is compared with a target conversion efficiency. In step 150, the inversion step 120, the calculation step 130 and the comparison step 140 are iterated block by block (such as steps 220 and 230 in FIG. 2). In step 160, the HAOS with the achieved conversion efficiency which is closest to the target conversion efficiency from step 140 is selected as an optimized HAOS.

Moreover, the method can further include the steps as follows. The inversion step 120, the calculation step 130, and the comparison step 140 are iterated under the conversion with a plurality of fundamental wavelengths block by block. Then, the achieved conversion efficiencies from the fundamental wavelengths of one HAOS with the inverted spatial distribution of domain orientation of the unit block are summed up. Furthermore, a record step is for recording the achieved conversion efficiency which is closest to the target conversion efficiency after the comparison step 140. When one achieved conversion efficiency is closer to the target conversion efficiency than another achieved conversion efficiency, the closer achieved conversion efficiency can be recorded. Then, when step 140 is iterated and generated another achieved conversion efficiency which is closer to the target conversion efficiency, the recorded achieved conversion efficiency would be replaced.

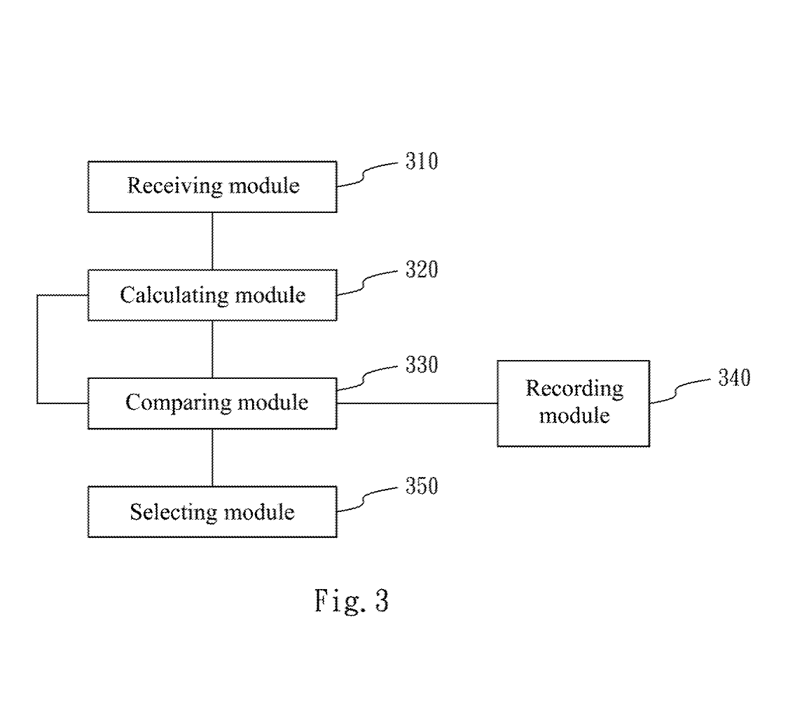

FIG. 3 is a functional block showing a system for optimizing a hyperfine aperiodic optical superlattice according to another embodiment of the present disclosure. In FIG. 3, the system can be applied to typical PCs, and includes a receiving module 310, a calculating module 320, a comparing module 330, a recording module 340 and a selecting module 350.

The receiving module 310 receives the HAOS data (such as length, material and temperature etc.) and divides the HAOS into a plurality of unit blocks with the same length. For an example, the HAOS is a LiNbO₃ crystal with length L and be divided into N unit blocks with the same length dx. Each of the unit blocks has the same spatial distribution of domain orientation, and the HAOS with an original conversion efficiency.

The calculating module 320 is connected to the receiving module 310 and calculates a conversion efficiency of the HAOS which has the one of the unit blocks with an inverted spatial distribution of domain orientation. In detail, the present disclosure provides the system for optimizing a HAOS by an iterative domino (ID) algorithm. Without loss of generality, if the pump is non-depleted, the conversion efficiency of the LiNbO₃ crystal at a fundamental wavelength λ is given by:

$$\begin{matrix}η ( λ ) = {η}_{norm} ( λ ) \cdot {d}_{R \text{-} eff}^{2} ( λ ) , & Eq . ( 1 ) \\ {d}_{R \text{-} eff} ( λ ) = \frac{1}{L} \vert {\int }_{0}^{L} d ( x ) {e}^{i Δ k \cdot x} d x \vert , & Eq . ( 2 )\end{matrix}$$

wherein ηₙₒᵣₘ(λ) is the normalized efficiency in units of %/W, Δk (a function of λ) is the wave vector mismatch, and d(x) represents the spatial distribution of domain orientations.

For HAOS, the reduced effective nonlinear coefficient d_{R-eff} can be rewritten as:

$$\begin{matrix}{d}_{R \text{-} eff} ( λ ) = \frac{1}{L} \vert {\sum }_{n = 1}^{N} {z}_{n} ( Δ k ) \vert , & Eq . ( 3 ) \\ {z}_{n} ( Δ k ) = {δ}_{n} \frac{{e}^{i Δ k \cdot {x}_{n}} - {e}^{i Δ k \cdot {x}_{n - 1}}}{Δ k} , & Eq . ( 4 )\end{matrix}$$

wherein δₙ(=1 or −1) and xₙ=n·dx denote the orientation and right boundary of the nth unit block, respectively; and zₙ(Δk) is a complex number contributed by the nth unit at the fundamental wavelength λ corresponding to some wave vector mismatch Δk.

When one of the N blocks (say the qth unit block) of the sample is inverted, i.e. δ_{q}′=−δ_{q}, the reduced effective nonlinear coefficient (thus the conversion efficiency) can be written as:

d′_{R-eff}=d_{R-eff}−2z_{q}(Δk). Eq. (5)

Therefore, the calculating module 320 calculates the conversion efficiency with the inverted spatial distribution of domain orientation as d_{R-eff}′=d_{R-eff}−2z_{q}(Δk) block by block.

The comparing module 330 is connected to the calculating module 320. The comparing module 330 is used for comparing the achieved conversion efficiency with a target conversion efficiency. In the comparing module 330, a fitness function F is set as:

$$F = {\sum }_{α = 1}^{M} \vert \frac{{η}_{α} - {η}_{α}^{( 0 )}}{{η}_{α}^{( 0 )}} {\vert}^{p} , \qquad Eq . ( 6 )$$

wherein p is a positive integer which can increase the difference of the shape of each fitness function (p takes 16 in general), α is the α th target wavelength which would be converted from the fundamental wavelength, η_{α}⁽⁰⁾(Σn_{α}⁽⁰⁾=1) and η_{α} represent the target conversion efficiency and the achieved conversion efficiency normalized to the peak efficiency η₀, of a periodic QPM grating of the same length L. Therefore, the F represents the comparing result between the target conversion efficiency and the achieved conversion efficiency; in other words, F represents how the achieved conversion efficiency closes to the target conversion efficiency. When F is smaller, the achieved conversion efficiency is better (“better” means the achieved conversion efficiency is closer to the target conversion efficiency), that is, the inverted spatial distribution of domain orientation is better. When F is larger, the achieved conversion efficiency is worse. Furthermore, the overall efficiency ηₜₒₜ≡Σ_{α=1}^{M}η_{α} and the average shape error Δη≡Σ_{α=1}^{M}|η_{α}−nₜₒₜ×η_{α}⁽⁰⁾|/ηₜₒₜ also can quantitatively measure the performance of the HAOS.

The selecting module 350 is connected to the comparing module 330. The selecting module 350 selects the HAOS with the achieved conversion efficiency which is closest to the target conversion efficiency as an optimizing HAOS.

The system of FIG. 3 can further include a recording module 340. The recording module 340 is connected to the comparing module 330 and the selecting module 350, and for recording the achieved conversion efficiency which is closest to the target conversion efficiency. In the present embodiment, F is smaller which would be recorded. Therefore, the selecting module 350 can select the HAOS with the achieved conversion efficiency which recorded in the recording module 340.

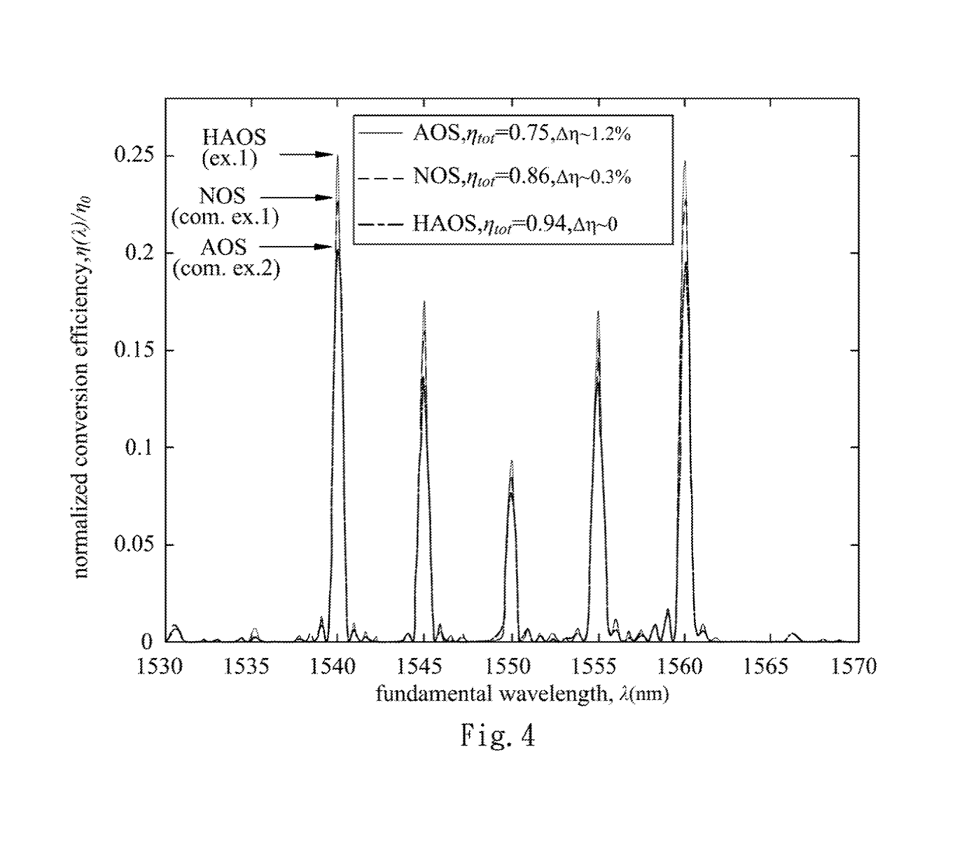

FIG. 4 illustrates a fundamental wavelength—normalized conversion efficiency spectrum of an example 1 (ex. 1), a comparison example 1 (com. ex. 1) and a comparison example 2 (com. ex. 2), wherein the example 1 is the HAOS optimized by the system of FIG. 3, the comparison example 1 is the AOS optimized by SA, and the comparison example 2 is the NOS optimized by GA. The crystal which be optimized in the examples with length L=1.89 cm, p=16 [Eq. (6)], and make sure that all the domain are longer than 4 μm. In FIG. 4, there are five PM peaks in V-shaped which are five target wavelengths. The HAOS of example 1 has N unit blocks, N=189,000, and each unit block with length dx=0.1 μM. The HAOS of example 1 achieves ηₜₒₜ=94% and Δη=5×10⁻⁵. However, the comparison example 1 and the comparison example 2 achieve ηₜₒₜ=75% and ηₜₒₜ=86% respectively. The minimum domain length is 8.9 μm (example 1, comparison example 1 and 2). In example 1, the system continues for 1,586 iterations taking 30 minutes by a typical PC (about 14 times faster than comparison example 1).

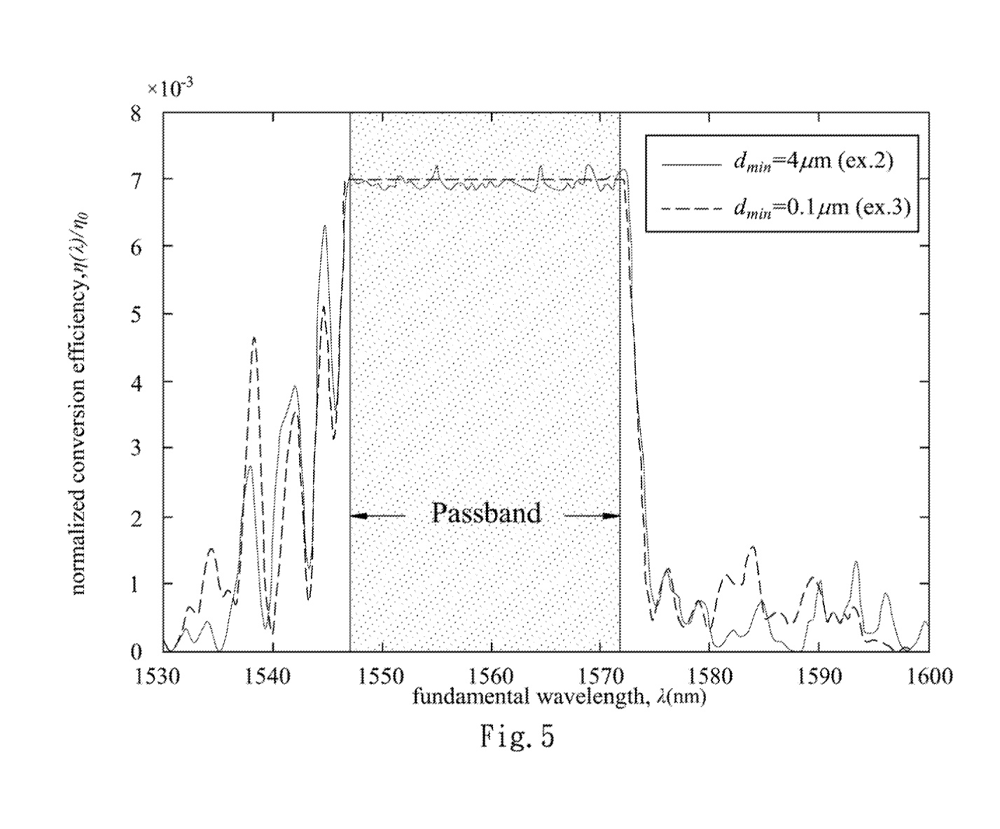

FIG. 5 illustrates a fundamental wavelength—normalized conversion efficiency spectrum of an example 2 (ex. 2) and example 3 (ex. 3), wherein example 2 with minimum domain length dₘᵢₙ of 4 μm, and example 3 with minimum domain length dₘᵢₙ of 0.1 μm. In FIG. 5, the shaded area represents the passband. In both example 2 and example 3, there are 101 PM peaks within λ=1547-1572 nm by using dx=0.2 um and N=94,500. FIG. 5 shows that the resulting PM tuning curve is continuous, since the peak spacing (0.25 nm) is smaller than the width of individual peak (0.6 nm).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for optimizing a hyperfine aperiodic optical superlattice, the method comprising:
dividing the hyperfine aperiodic optical superlattice into a plurality of unit blocks with the same length, wherein the unit blocks has same spatial distribution of domain orientation, and the hyperfine aperiodic optical superlattice with an original conversion efficiency;
performing an inversion step for inverting the spatial distribution of domain orientation of one of the unit blocks;
performing a calculation step for calculating an achieved conversion efficiency from a fundamental wavelength into a target wavelength of the hyperfine aperiodic optical superlattice which has the one of the unit blocks with the inverted spatial distribution of domain orientation;
performing a comparison step for comparing the achieved conversion efficiency with a target conversion efficiency;
iterating the inversion step, the calculation step and the comparison step on the others unit blocks block by block;
selecting the hyperfine aperiodic optical superlattice with the achieved conversion efficiency which is closest to the target conversion efficiency as an optimized hyperfine aperiodic optical superlattice.

2. The method of claim 1, further comprising:
iterating the inversion step, the calculation step, and the comparison step with a plurality of fundamental wavelengths block by block; and
summing up a plurality of achieved conversion efficiencies from the plurality of fundamental wavelengths of one hyperfine aperiodic optical superlattice with the inverted spatial distribution of domain orientation of the unit block.

3. The method of claim 1, further comprising:
performing a record step for recording the achieved conversion efficiency which is closest to the target conversion efficiency after the comparison step.

4. A system for optimizing a hyperfine aperiodic optical superlattice, the system comprising:
a receiving module for receiving the hyperfine aperiodic optical superlattice data and dividing the hyperfine aperiodic optical superlattice into a plurality of unit blocks with the same length wherein the unit blocks has same spatial distribution of domain orientation, and the hyperfine aperiodic optical superlattice with an original conversion efficiency;
a calculating module connected to the receiving module for calculating an achieved conversion efficiency of the hyperfine aperiodic optical superlattice which has the one of the unit blocks with an inverted spatial distribution of domain orientation, wherein the spatial distribution of domain orientation of each of the unit blocks is inverted block by block;
a comparing module connected to the calculating module, wherein the comparing module is used for comparing the achieved conversion efficiency with a target conversion efficiency; and
a selecting module connected to the comparing module, wherein the selecting module selects the hyperfine aperiodic optical superlattice with the achieved conversion efficiency which is closest to the target conversion efficiency as an optimizing hyperfine aperiodic optical superlattice.

5. The system of claim 1, further comprising:
a recording module connecting the comparing module and the selecting module for recording the achieved conversion efficiency which is closest to the target conversion efficiency.
